(19) United States
(12) Patent Application Publication
(10) Pub. No.: US 2014/0323292 A1
(43) Pub. Date: Oct. 30, 2014

(54) SUPPORTED METAL CATALYST AND METHOD OF MAKING THE CATALYST

(71) Applicant: STC.UNM, Albuquerque, NM (US)

(72) Inventors: Claudia Catalina Luhrs, Rio Rancho, NM (US); Eric Brosha, Los Alamos, NM (US); Jonathan Phillips, Albuquerque, NM (US)

(73) Assignee: STC.UNM, Albuquerque, NM (US)

(21) Appl. No.: 14/359,087

(22) PCT Filed: Nov. 21, 2012
(86) PCT No.: PCT/US2012/066395

§ 371 Date: May 16, 2014

Related U.S. Application Data
(60) Provisional application No. 61/563,646, filed on Nov. 25, 2011.

(51) Int. Cl. B01J 23/42; B01J 21/04; B01J 21/18; B01J 21/06

(52) U.S. Cl. CPC B01J 23/42; B01J 21/063; B01J 21/04; B01J 21/18
USPC 502/182; 502/300; 502/350; 502/355; 502/339

(57) ABSTRACT

Provided is a method for making a supported metal catalyst. The method includes forming a mixture comprising a high surface area support, a reducing agent precursor that decomposes to produce reducing gases below about 1200° C., and a metal catalyst precursor. The mixture is heated to a temperature sufficient to decompose the reducing agent precursor to produce a reducing agent, and then cooled to form the supported metal catalyst.

### RELATED APPLICATIONS

This application claims priority from U.S. Provisional Patent Application Ser. No. 61/563,646, filed Nov. 25, 2011, which is hereby incorporated by reference in its entirety.

### FIELD OF THE INVENTION

This invention relates generally to the field of metal catalysts and, more specifically, to supported metal catalyst structures.

### BACKGROUND OF THE INVENTION

The behavior of supported metal catalysts is not only a function of composition, but also of the method of preparation. One clear example of a property that is not simply a function of the composition, or even initial metal dispersion, is the stability of catalysts. Automotive 3-way catalysts lose on the order of half their activity during a mandated 100,000 mile lifetime, primarily due to the sintering of the metal catalyst particles in the high temperature (approximately 650° C.), highly corrosive engine exhaust environment. Improving 3-way catalyst lifetime could dramatically reduce the $10 billion dollars/yr the industry spends on noble metals, and indeed, there is progress. Catalysts made using a plasma method, Aerosol-Through-Plasma (A-T-P), are similar in composition and initial dispersion to those prepared using the more conventional incipient wetness method. Yet, the A-T-P catalysts and even A-T-P produced ceramics are far more stable over time.

Another example is the concern for development of stable Pt/C catalysts for fuel cell applications. It is clear that the stability of the platinum is a function of pre-treatment of the carbon surface and method of metal loading, among other things. Finding a formula for improving stability of platinum supported on conductive supports would be desirable for enabling wide spread deployment of fuel cell powered vehicles, for example.

The impact of preparation technique on supported metal catalyst behavior justifies a search for new preparation technologies and methods to test them. One example of a published process is known as Reductive Expansion Process (RES), which has been employed to make graphene from graphite oxide and micron and sub-micron scale metal particles from metal oxide precursors.

The unique reducing chemistry of the RES process was employed in earlier work by these same inventors to convert metal nitrate, hydroxide and oxide precursor salts to unsupported metallic particles. These technologies use essentially the same chemistry and protocol (mixing and heating) as that described herein, but the earlier products, metal particles, are not supported metal catalysts.

Moreover, the extension of the concept to supported metal catalysts is not obvious for many reasons. For example, the supported metal catalyst particles produced in the present work can be smaller, for example, three orders of magnitude smaller in volume, than unsupported metal particles produced in earlier work. Also, the extension to supported metal catalysts is not obvious because the earlier work did not include producing the particles on a support. Unsupported metal particles of any size are not effective, hence not employed, for nearly all catalytic applications, including 3-way catalysts for automotive exhaust mitigation. The support is beneficial in that it can enable the production of nanoscale particles that may not otherwise be produced using a variant on the RES process without a support.

Moreover, the support maintains the physical stability of the catalyst at higher temperatures. Without bonding to a thermally stable support, nanoscale metal particles rapidly sinter at temperatures employed in most catalytic processes.

A key to the ‘reductive synthesis’ of metal particles was shown, on the basis of exhaustive studies, to be the reducing gas species formed by the decomposition of the urea. For example, in the absence of urea only metal oxide particles formed. While compounds other than urea can be employed, it is believed that similar processes may occur in the production of catalysts described in the Examples of the present application.

The subject matter of the present application is the latest manifestation of repeated efforts that have been made to create supported metal catalysts of virtually identical compositions, but superior performance, using novel fabrication techniques. These efforts are based on the postulate that even though the compositions may be similar, changes in the preparation method may subtly impact particle morphology, interface chemistry, etc., leading to significant improvements in catalyst performance. For example, intense efforts, including literally hundreds of studies, were made (mainly in the 1975-1990 time frame) to employ metal carbonyls as the precursors to supported metal catalyst particles. This led to the creation of catalysts generated using carbonyls superior for some catalytic applications to catalysts of the same composition made using the standard incipient wetness technology. Aerosol-through-plasma (A-T-P) is an even more recent example of a novel fabrication technique that produces, in this case, superior sinter resistant supported catalysts.

Therefore, developing an alternative to known methods for producing metal catalysts would be a desirable advance in the art.

### SUMMARY

An embodiment of the present disclosure is directed to a method for making a supported metal catalyst. The method comprises forming a mixture comprising a high surface area support, a reducing agent precursor that decomposes to produce reducing gases below about 1200 degrees C., and a metal catalyst precursor. The mixture is heated in a non-oxidizing atmosphere to a temperature sufficient to decompose the reducing agent precursor to produce a reducing agent, and then cooled to form the supported metal catalyst.

Another embodiment of the present disclosure is directed to a supported metal catalyst. The catalyst is made by a method comprising forming a mixture comprising a high surface area support, a reducing agent precursor that decomposes to produce reducing gases below 1200 degrees C., and a metal catalyst precursor. The mixture is heated in a non-oxidizing atmosphere to a temperature above a decomposition temperature of the reducing agent precursor then cooled to form the supported metal catalyst.

Additional advantages of the embodiments will be set forth in part in the description which follows, and in part will be understood from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a flow chart of a process for making a supported metal catalyst, according to an embodiment of the present disclosure.

FIG. 2 is an image showing the SEM of 5 wt % Pt on Anatase TiO₂, according to an example of the present disclosure.

FIGS. 3A to 3D are images showing TEM analysis of Pt particles on anatase TiO₂, according to an example of the present disclosure.

FIG. 4 is a graphical representation of XRD of 5% Pt/TiO₂ (Anatase), according to an example of the present disclosure.

FIG. 5 show Dark Field Images of 1 wt % Pt/γAl₂O₃, according to an example of the present disclosure.

FIGS. 6A to 6B are TEM images showing no clear image of particles can be found, using TEM, on 5% Pt/Al₂O₃, according to an example of the present disclosure.

FIGS. 7A to 7B are images showing Normal and Dark Field TEM images of 5% Pt/Al₂O₃ after prolonged exposure to an electron beam, according to an example of the present disclosure.

FIGS. 8A to 8B are images showing TEM Studies of Ni Particles on graphene, according to an example of the present disclosure.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present invention. It is intended that the specification and examples be considered as examples only. The various embodiments are not necessarily mutually exclusive, as some embodiments can be combined with one or more other embodiments to form new embodiments.

The present teachings provide a novel method for making supported metal catalysts. In various embodiments, the method can include heating a physical mixture comprising a high surface area support, a reducing agent precursor and a metal precursor.

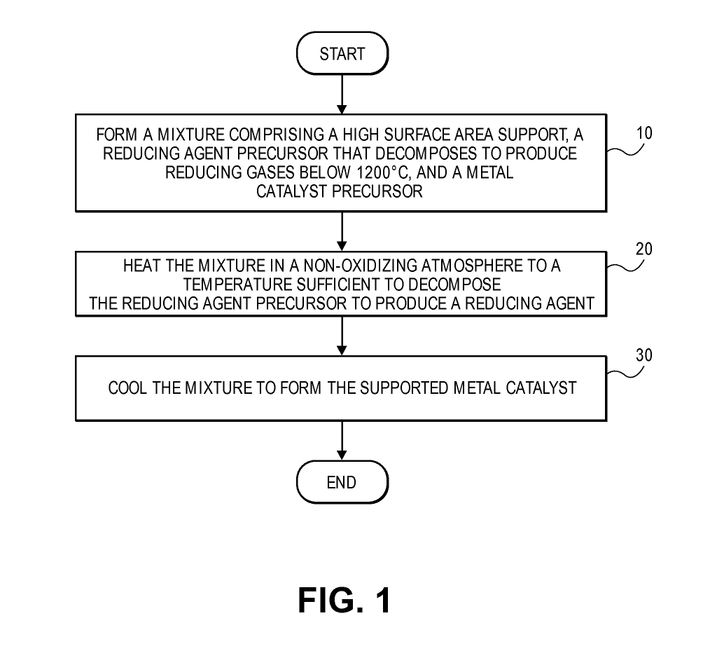

FIG. 1 shows a flow chart of a method of making a supported metal catalyst, according to an embodiment of the present disclosure. The process can comprise a plurality of steps, (e.g., two, three or more). As shown at reference number 10 of FIG. 1, the method comprises mixing support material, metal catalyst precursor and a reducing agent precursor that decomposes upon heating to form a reducing agent. The ingredients can be mixed in any desired order, or all at once. Any suitable mixing method that provides the desired amount of mixing can be employed.

Any suitable amount of the support material, metal catalyst precursor and reducing agent precursor can be employed that will result in a supported metal catalyst. In an embodiment, the support can make up more than 50% of the mixture by weight, and the molar ratio of the urea:metal atoms in metal precursor can be greater than one. Concentrations and ratios outside of these ranges can also be employed.

As shown at reference number 20, the mixture is rapidly heated to at least the decomposition temperature of the decomposing reagent. Heating to the desired temperature can be accomplished over any suitable time period, such as, for example, about 0.1 seconds to about 1000 seconds. The mixture can then be cooled. The residue remaining after cooling is supported metal catalysts.

The high surface area support or group of supports formed of, for example, carbon, such as a high surface area carbon, carbon nanospheres, carbon nanotubes, graphene or activated carbon, carbon oxide, alumina, silica, titania, magnesia, ceria, or a lanthanide group oxide, or any high surface area ceramic including nitrides, borides and oxides. The high surface area support or group of supports can have a surface area of, for example, about 10 to about 2000 m²/g (e.g. high surface area carbon, high surface area alumina or high surface area metal precursor salts (e.g. Pt NH₃(NO₃)₂)).

The reducing agent precursor can be any reagent that decomposes to produce reducing gases below about 1200° C. One example of a suitable reducing agent precursor is urea. Another example is hydrazine.

The metal catalyst precursor can be any compound that includes the desired catalyst metal. Examples of catalytic metals include transition metals, precious metals or noble metals, either as atoms or clusters, such as ruthenium, rhodium, palladium, silver, osmium, iridium, platinum, gold, iron or others metals of Groups 3 to 12 of the periodic table. Examples of compounds include metal halides, metal amines, metal-organic compounds, a metal containing molecule with an organic cyclic group, metal carbonyls, metal azides and metal salts, such as nitrates,. Other examples include metal hydroxides and some metal oxides. Specific examples include such compounds as PtNH₃(NO₃)₂, PdCl, PtCl, FeCl, or other metal chlorides. Alloy particles can be generated on a support by including precursor compounds that contain a plurality of metals in the precursor mixture. One of ordinary skill in the art could readily determine additional suitable metal precursor compounds.

As discussed above, the mixture is heated to a temperature sufficient to decompose the reducing agent precursor to create reducing gases. For example, in the case of urea the temperature can be above approximately 600° C. The heating process can take place in many fashions. Non-limiting examples include: i) the mixture can be heated in a batch, or ii) the mixture can be passed through a heating zone continuously, such as a gas/solid aerosol passed through a tube furnace. In general the heating can be done in a non-oxidizing environment at approximately ambient pressure. Examples of suitable non-oxidizing environments include inert gases, such as N₂, He, and Ar, and reducing gases, such as hydrogen gas. The mix can be kept at the decomposition temperature for a relatively short time, such as, for example, 5 minutes or less, and then the system rapidly cooled. Although the range of acceptable heating and cooling protocols is large, experience suggests rapid heating from ambient to target temperature in about 5 minutes or less, followed by a short soak time, such as about 0.1 seconds to about 600 seconds

The solid residue remaining after the above process will be a supported metal catalyst. In an embodiment, the metal catalyst is in the form of nanoscale particles formed on the substrate. For example, the particles can have a maximum dimension of less than 50 nm, or less than 1 nm.

The methods of the present disclosure can provide one or more of the following advantages: simplicity of technique, improved speed of the process, ability to be performed as a batch process and relatively easy scaling of the process for manufacturing using standard engineering methods.

The present RES method, as disclosed herein, may also lead to the creation of catalysts that are superior, for some applications, to those made using other techniques. Given the unique features of the method, this is a rational expectation. In particular, RES is unique in three broad respects: i) the catalyst particles are formed in a single step during heating, ii) the metal interacts with the surface in a reducing environment (due to urea decomposition products) and iii) the time at high temperature is very short, hence limiting sintering. In contrast, both incipient wetness and other methods, including carbonyl decomposition, require a different series of steps, and require significant high temperature processing time. For example, in an incipient wetness method, metal is deposited on the surface in an oxygen neutral environment, followed by calcination in an oxidizing environment. In a final step the metal is chemically reduced generally at high temperature under hydrogen for lengthy periods.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices may exhibit various different properties and uses in accordance with the disclosure above and as pointed out hereinafter.

### EXAMPLES

The exemplary RES processes below can include: i) physical mixing of metal precursors, metal oxide supports and a chemical reductant, such as urea, that thermally decomposes to release reducing gases, ii) rapidly heating the physical mixture, generally in an oxygen free environment to a temperature in excess of the decomposition temperature of the reductant. As shown below, these processes can lead to the formation of highly dispersed metal particles on the metal oxide.

Supported metal catalysts, both Pt and Ni, of appropriate size for real catalytic applications (approximately 10 nm), were generated on three different supports (alumina, titantia and carbon). Four different model ‘supported metal catalysts’ were made: i) 5 wt % Pt on anatase TiO₂ (Sigma Aldrich, ˜50 m²/g)), ii) 1% Pt on high surface γ-alumina (Sigma Aldrich ˜100 m²/g)), iii) 5% Pt on high surface γ-alumina and iv) 10% Ni on graphene (generated in our lab from graphite oxide). In all cases the platinum metal precursor was PtNH₃(NO₃)₂ (Sigma-Aldrich). The graphite oxide was graphite oxide nickel nitrate (Sigma Aldrich).

The initial step in all cases was to thoroughly grind components together. This is actually a two stage process. The first step was a thorough mixing. Using a mortar and pestle the platinum precursor was hand ground together with urea in 1:5 molar ratio (Table I). Next, the pre-ground mix was added to high surface area ceramic support material, and again ground thoroughly.

The second step, described below, is designed to disperse platinum onto the support surface by a process of ‘reductive expansion’. That is, the mix was heated rapidly such that the metal precursor and urea decompose rapidly and ‘explosively’ in the same time frame. Specifically, the ground precursor mix (approximately 1 g) was added to a small alumina boat, and the boat placed at the center of an 18″×1″ diameter quartz tube. This tube was thoroughly flushed with flowing nitrogen, then placed, with nitrogen still flowing, into a pre-heated (800° C.) 12″ laboratory clamshell furnace. The tube was removed from the clamshell furnace after approximately 180 seconds and the ‘catalyst’ produced by the process rapidly cooled in flowing nitrogen.

The time employed, 90 seconds, and the temperature (initially 800° C.) were selected on the basis of earlier successful generation of nano metal particles from metal nitrates, and graphene from graphene oxide.

Characterization: A scanning electron microscope (SEM, Hitachi S5200 nano), and a transmission electron microscope (TEM, JEOL 2010) equipped with energy dispersive spectroscopy (EDS) were employed. For both SEM and TEM, samples were prepared ‘dry’. That is, the powders were removed from the alumina boat in which they were created and placed directly on sample holders. An X-ray diffractomer (XRD), Scintag Pad V diffractometer/goniometer with Scintillation detector and Datascan software was used for the XRD studies.

### EXAMPLE 1

### 5 wt % Pt/TiO₂

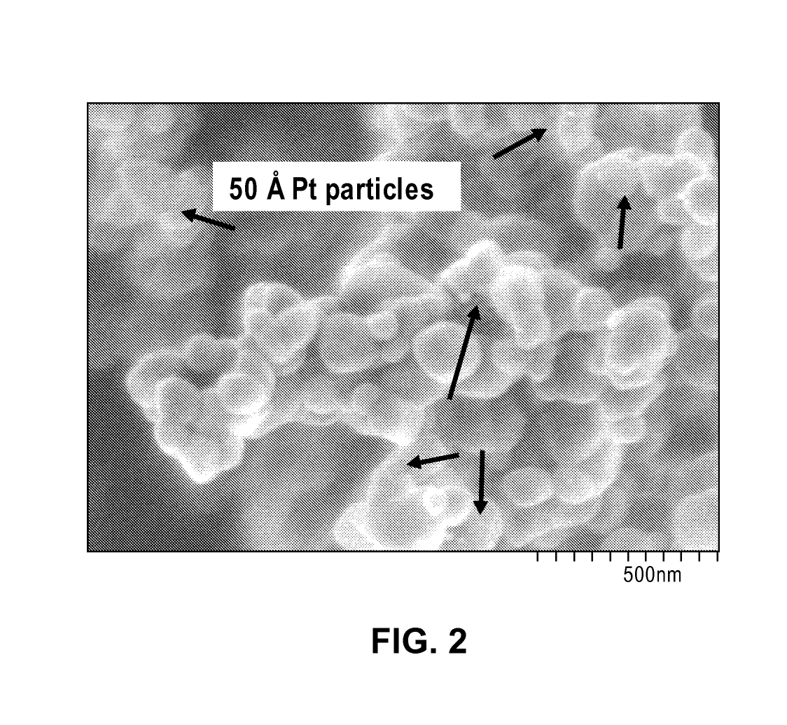

The clearest indication of the success of the process is found from electron microscope evaluation. As shown in FIG. 2, SEM images show platinum particles broadly distributed across the entire surface of the TiO₂ substrate. Although SEM is not completely appropriate for the precise determination of particles on the scale of nanometers, it does provide a reasonable qualitative approximate. Indeed, as marked, it would appear that none or almost none of the particles are greater than about 100 A in diameter. All of the particles are less than 50 nm in maximum dimension.

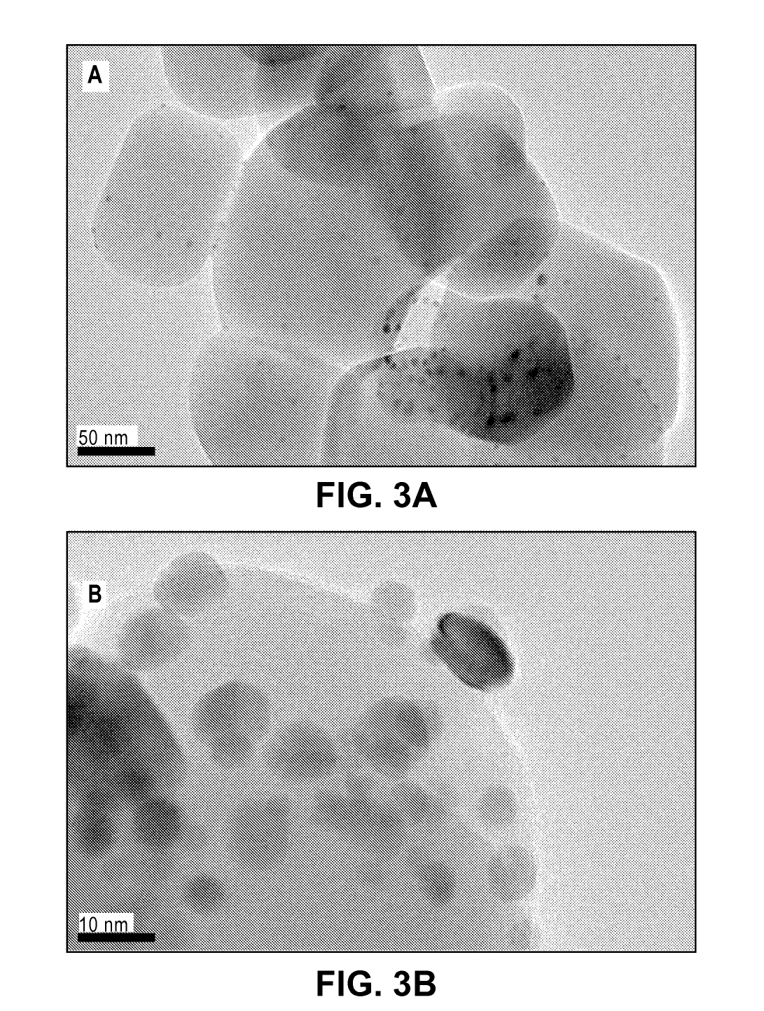

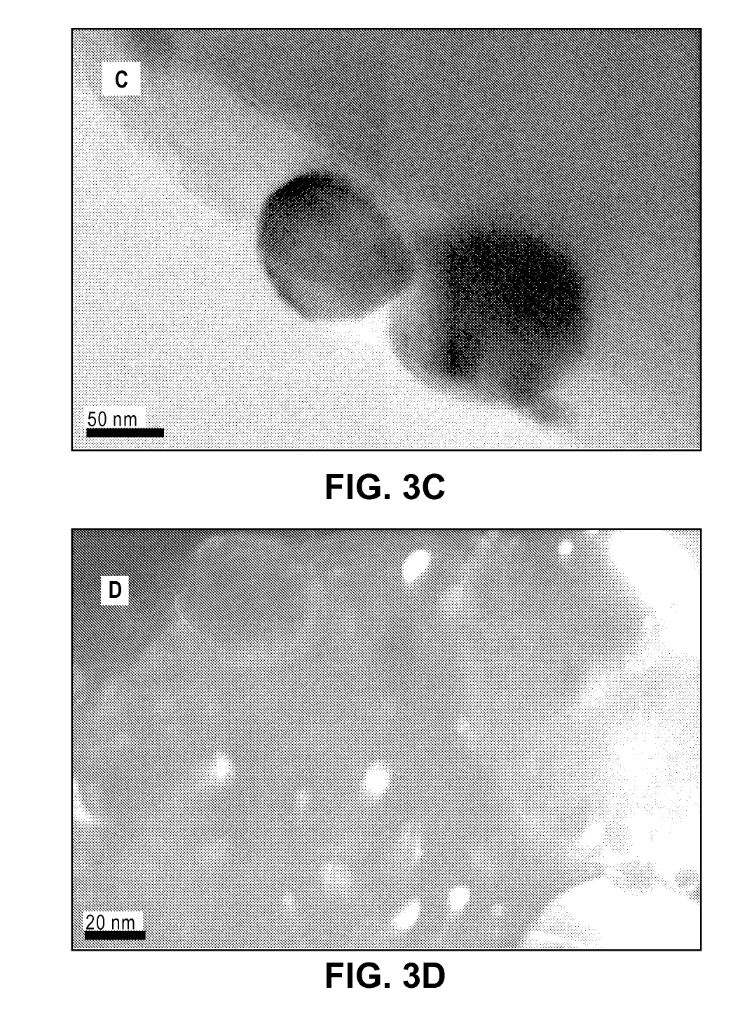

The particles were also examined using Transmission Electron Microscopy, as shown in FIGS. 3A and 3B. A close examination suggests similar conclusions to those found using SEM: highly dispersed, crystalline platinum particles, most of which are no larger than 100 Å, are found across the entire surface. In FIGS. 3A) and 3B), virtually all particles are less than 10 nm, maximum dimension. FIG. 3C) illustrates interplanar spacing matches Pt <111>. In FIG. 3D) Dark field imaging highlights Pt particles.

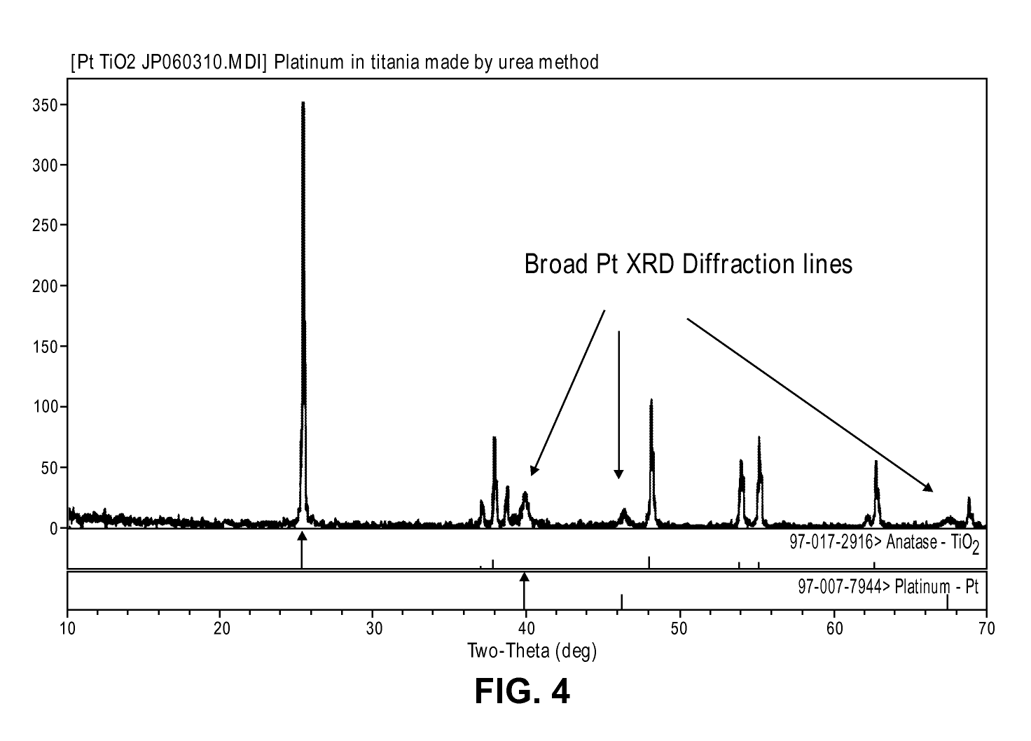

XRD was the final method of analysis employed. As shown in FIG. 4, all the platinum lines were broadened, consistent with very small particles. A simple quantitative analysis employing the Debye-Scherrer method indicates the average Pt particle size was of the order of 15 nm, slightly larger than that suggested from the TEM analysis, but still consistent with the formation of small particles on titania supports. All lines can be identified with either platinum or titania (anatase).

### EXAMPLE 2

### 1 wt % Pt/γAl₂O₃

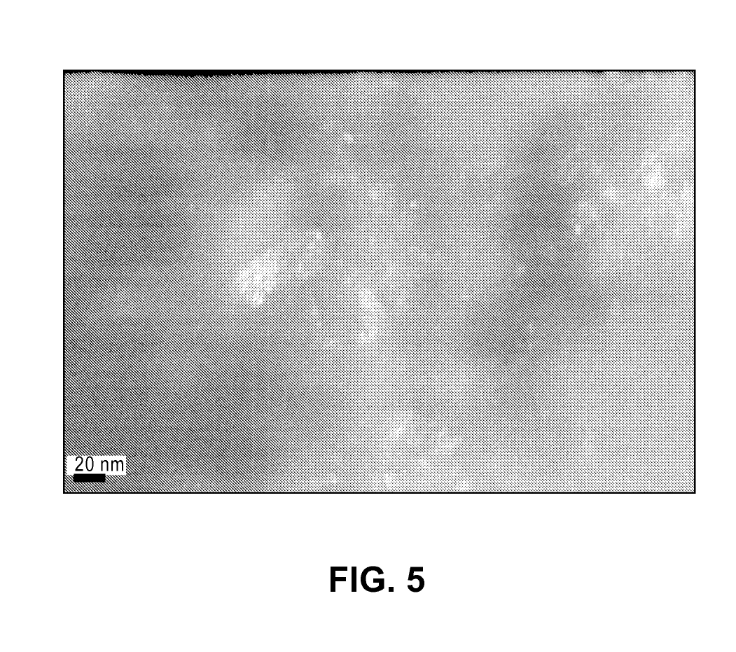

Remarkably, there were no ‘well formed’ particles visible using TEM. As shown in FIG. 5 there is the suggestion of very small particles (<5 nm) in the dark field imaging. Dark field imaging suggests (not certain) that much of the platinum is found in linear ‘smears’, of maximum dimension approximately 10 nm×2 nm. This suggests very strong metal-support interaction, which may lead to a low angle of ‘wetting’.

### EXAMPLE 3

### 5 wt % Pt/γAl₂O₃

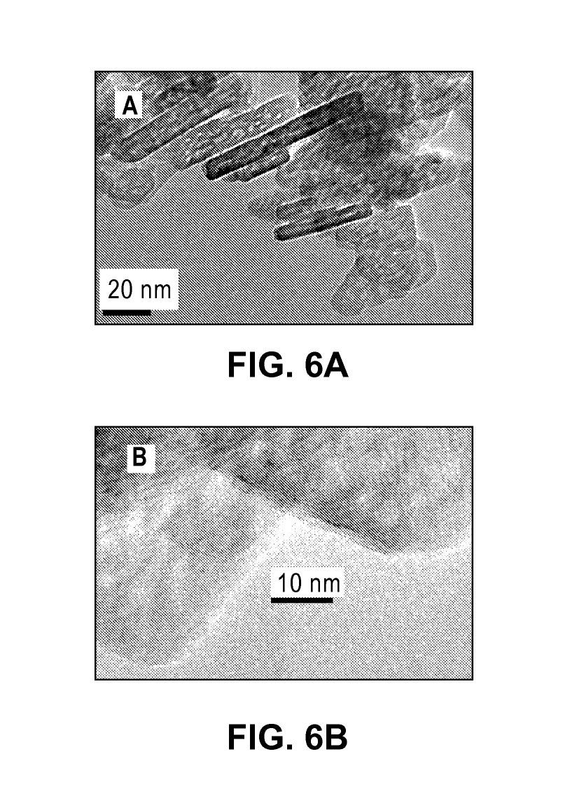

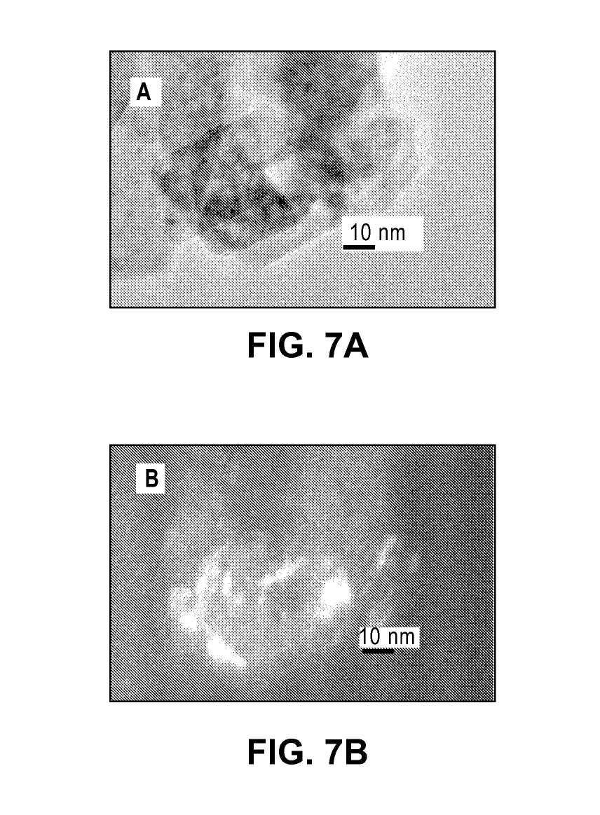

As shown in FIG. 6A, TEM of 5 wt % Pt/γAl₂O₃ appears to show areas of contrast, but few if any particles. At even lower levels of magnification, particles are clearly visible on titania (FIG. 2A). As shown in FIG. 6B, at high levels of magnification some diffraction lines are clearly visible, but no clear particles are visible. FIGS. 7A and 7B show Normal and Dark Field TEM images of 5% Pt/Al₂O₃ after prolonged exposure to an electron beam.

FIG. 7A shows a normal image that suggests particles formed on the alumina (<5 nm) after prolonged exposure to electron beam in the TEM. The dark field image of FIG. 7B suggests an imperfect correlation between the ‘particle like’ spots in the normal image and platinum, seen in the dark field image. No spherical objects (particles) are visible. Both normal and dark field images are only consistent with highly dispersed Pt, which is strongly bound to the alumina substrate.

On neither the 1 weight % sample, nor the 5 weight %/γAl₂O₃ sample, were ‘well formed’ metal particles observed using either SEM or TEM. In the case of SEM, extended observation did not reveal particles larger than about 2 nm. Initial TEM studies revealed structures on the 5 weight %/γAl₂O₃ that appear similar to those found in the dark field image of the 1 wt % sample. However, after extended (>15 minutes) study of small areas, particle structures were observed. This suggests that the electron-beam actually modified the morphology of the platinum. It is well known that extended observation of a small area with TEM will modify the characteristics of virtually any material. This is generally attributed to local heating caused by the high energy electron bombardment.

Logic and literature suggest two possible characteristics of the RES process on alumina. First, in order to produce such extremely small particles, the process initially generates very small metal clusters, such as, for example, 1 nm or less, or a diameter of 60 atoms or less. (In fact, all data is consistent with the initial formation of mono-atomic metal species.) Second, these clusters strongly interact with the support such that even at the high temperatures encountered, sintering does not occur.

### EXAMPLE 4

### 10% Ni on Graphene

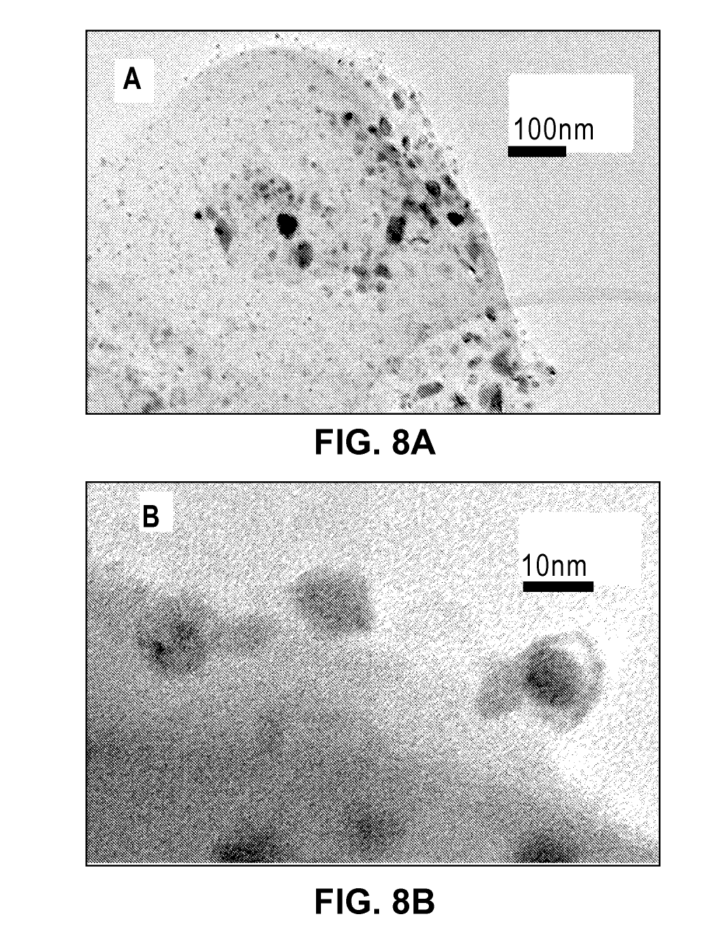

FIGS. 8A and 8B show images of TEM Studies of Ni Particles on graphene prepared from graphitic oxide. FIG. 8A shows that most particles are irregular in form and less than 10 nm across. FIG. 8B shows that most particles are graphite coated (e.g. see particle just below scale bar).

The use of graphene or graphite oxide as a support for catalyst particles is not standard. In fact, carbon is rarely employed as a catalyst support because on carbons, particle sintering is generally extremely rapid. In the present case there is reason to believe that the RES method results in the removal of surface bound oxygen, and the concomitant creation of unsaturated carbon surface atoms. These ‘surface radicals’ in turn bond to the metal atoms created by the RES process. The net result is the creation of metal atoms directly linked to the carbon matrix. (Precedent can be found in the scientific literature that supports this postulate.) Indeed, FIG. 8A shows that most of the particles on the sample are less than about 50 nm across. This is a remarkably small catalyst particle size for a 10% metal loaded carbon supported catalyst. Moreover, the particles are irregular in form, and appear to be ‘flat’ (contrast with particle on TiO₂, FIG. 2). This suggests strong bonding to the support. This is not expected for particles formed on carbon using the standard incipient wetness technique. The result may be a unique chemistry and a sinter resistant metal catalyst.

While the invention has been illustrated respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for making a supported metal catalyst comprising:
forming a mixture comprising a high surface area support, a reducing agent precursor that decomposes to produce reducing gases below about 1200° C., and a metal catalyst precursor;
heating the mixture in a non-oxidizing atmosphere to a temperature sufficient to decompose the reducing agent precursor to produce a reducing agent; and
cooling the mixture to form the supported metal catalyst.

2. The method of claim 1, wherein the high surface area support has a surface area ranging from about 10 m²/g to about 2000 m²/g.

3. The method of claim 2, wherein the high surface area support comprises at least one of carbon, carbon oxide, carbon nanotubes, graphene, graphite oxide, alumina, silica, titania, magnesia, ceria, a ceramic comprising nitride, a ceramic comprising boride or a ceramic comprising oxide.

4. The method of claim 2, wherein the high surface area support comprises at least one of a high surface area carbon, activated carbon, carbon nanospheres, or a lanthanide group oxide.

5. The method of claim 1, wherein the reducing agent precursor is urea.

6. The method of claim 5, wherein and the mixture is heated to a temperature above 600° C.

7. The method of claim 1 in which the metal precursor is chosen from a metal amine complex, a metal salt, a metal-organic compound, a metal containing molecule with an organic cyclic group, a metal azide, a metal carbonyl, a metal oxide, a metal hydroxide or combinations thereof.

8. The method of claim 1, wherein the metal precursor comprises one or more precious metal atoms or transition metal atoms.

9. The method of claim 1 wherein the metal precursor comprises one or more noble group metal atoms.

10. The method of claim 1, wherein the metal precursor comprises Pt atoms, Pd atoms, Ni atoms or Fe atoms

11. The method of claim 1 wherein the metal precursor comprises at least one of a plurality of different compounds or a plurality of metal species.

12. The method of claim 1, wherein the supported metal catalyst comprises the high surface area support at more than 50% of the mixture by weight; and the molar ratio of the urea:metal atoms in the metal precursor is greater than one.

13. A supported metal catalyst formed by a method comprising
forming a mixture comprising a high surface area support, a reducing agent precursor that decomposes to produce reducing gases below about 1200° C., and a metal precursor;
heating the mixture in a non-oxidizing atmosphere to a temperature above a decomposition temperature of the reducing agent precursor; and
cooling the mixture to form the supported metal catalyst.

14. The supported metal catalyst of claim 13, wherein the high surface area support has a surface area ranging from about 10 m²/g to about 2000 m²/g.

15. The supported metal catalyst of claim 14, wherein the high surface area support comprises at least one of carbon, carbon oxide, carbon nanotubes, graphene, graphite oxide, alumina, silica, titania, magnesia, ceria, a ceramic comprising nitride, a ceramic comprising boride or a ceramic comprising oxide.

16. The supported metal catalyst of claim 14, wherein the high surface area support comprises at least one of a high surface area carbon, activated carbon, carbon nanospheres, or a lanthanide group oxide.

17. The supported metal catalyst of claim 13, wherein the reducing agent precursor is urea.

18. The supported metal catalyst of claim 13, wherein the metal precursor comprises one or more precious metal atoms or transition metal atoms.

19. The supported metal catalyst of claim 13, wherein the metal precursor comprises one or more noble group metal atoms.

20. The supported metal catalyst of claim 13, wherein the metal precursor comprises Pt atoms, Pd atoms, Ni atoms or Fe atoms.

21. The supported metal catalyst of claim 13, wherein the supported metal catalyst comprises the high surface area support at more than 50% of the mixture by weight; and the molar ratio of the urea:metal atoms in the metal precursor is greater than one.
